(19) United States
(12) Patent Application Publication
(10) Pub. No.: US 2005/0230343 A1
(43) Pub. Date: Oct. 20, 2005

(54) Baby formula preparation device

(76) Inventor: John Huber, Sherman Oaks, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/109,107

(22) Filed: Apr. 18, 2005

Related U.S. Application Data
(60) Provisional application No. 60/564,103, filed on Apr. 20, 2004.

(51) Int. Cl. A61J 11/00

(52) U.S. Cl. 215/387

(57) ABSTRACT

A baby formula stirring and dispensing mechanism includes a motor-driven auger disposed in a lower portion of a formula hopper for dispensing a desired quantity of the powdered baby formula from the hopper. A mixing wheel disposed in the hopper rotates and stirs the baby powder formula as the auger is rotated. Water is pumped from a water storage tank to a smaller heating reservoir where it is heated to the desired temperature. A discharge nozzle receives and mixes the heated water and a corresponding amount of powdered baby formula for delivery to a baby bottle.

### RELATED APPLICATION

This application claims priority to U.S. Provisional Application Ser. No. 60/564,103, filed Apr. 20, 2004.

### BACKGROUND OF THE INVENTION

The present invention generally relates to the preparation of baby formula. More particularly, the present invention relates to a crib side baby formula mixing and dispensing apparatus.

The problem exists that parents have many new responsibilities and expenses from a child that did not exist before their child was born. A feeding schedule for a baby typically includes feeding intervals between a minimum of about three hours and the maximum of about four hours. The majority of babies naturally adapt to the schedule within a few weeks. Naturally, the schedule intervals may be shifted to those most convenient for the parents. However, no matter what the schedule, night-time feeding is mandated by the baby's needs.

Attempting to lower their expenses, many parents when dealing with baby formula prefer to buy less expensive dry baby formula over more expensive pre-mixed liquid formula. However, the problem with dry formula it that there are many inconvenient and time-consuming procedures to be done in order to prepare it. Yet, with pre-mixed formula there are still procedures to be done to get the formula into the bottle and then warm it up to serving temperature. Even with a prepared formula, it can be very frustrating listening to a baby cry while waiting for the bottle to warm. Dry formula preparation can be considerably more painstaking than pre-mixed, and on top of that both can be even worse when preparing in the late evening and early morning, particularly when the baby is crying.

Thus, feedings during the night must be expedient, since any time required for the feeding reduces the care giver's own amount of rest and sleep, and may adversely impact the care giver's normal sleep pattern. The baby is also more inclined to return to sleep if he/she receives the infant formula in a timely manner. Otherwise, if allowed to become agitated when hungry and the food is not immediately forthcoming, the baby may not return to sleep as readily.

Thus, some parents or care givers attempt to shorten the preparation time of either dry or pre-mixed formula by microwaving, but it has been discovered that many essential vitamins and minerals are removed from both types of formula in the process and that hot spots can be generated within the bottle. Furthermore, the baby's room or crib is typically not conveniently located to the kitchen, refrigerator and stove/microwave where the bottle is prepared for feeding.

Accordingly, there is a continuing need for a baby formula mixing and dispensing unit which can mix the less expensive dry formula with pre-heated water conveniently at the crib side so that a parent responding to the baby's crying request for food can conveniently comfort and soothe the baby while simultaneously preparing the baby formula for use. The present invention fulfills these needs and provides other related advantages.

### SUMMARY OF THE INVENTION

The present invention is directed to a device for preparing baby formula by mixing powdered baby formula with pre-heated water. The device of the present invention can be conveniently placed at the crib side, or within the baby's room, so that a parent responding to a baby's crying request for food can conveniently comfort and soothe the baby while simultaneously preparing the baby formula for use.

The device comprises a powdered baby formula hopper having a baby formula stirring and dispensing mechanism. In a particularly preferred embodiment, the hopper is removable from a housing of the device.

The stirring and dispensing mechanism is used to stir the powdered baby formula, and dispense a desired quantity of the powdered baby formula from the hopper. In a particularly preferred embodiment, the stirring and dispensing mechanism includes a motor-driven auger positioned in a lower portion of the hopper. A mixing wheel is disposed in the hopper and has teeth which are engagable with the auger so that the wheel rotates as the auger is rotated.

A heated water dispensing system controllably dispenses a desired quantity of heated water. This system comprises a water heating reservoir fluidly coupled to a water storage tank. Typically, a pump is used to pump water from the storage tank to the heating reservoir. The heating reservoir preferably has a smaller volume than the storage tank, enabling the water to be heated more quickly. Preferably, the storage tank is removable from the housing of the device, and includes an outlet having a valve adapted to permit water to flow or be pumped from the storage tank to the heating reservoir.

A heater is operably associated with the heating reservoir or heating bottle within the heating reservoir to a predetermined temperature. A temperature sensor is operably associated with the heating reservoir and heater to monitor the temperature of the water in the heating reservoir.

In one embodiment, the water in the heating reservoir is heated to approximately body temperature and discharged from the device at this temperature. In another embodiment, the water in the heating reservoir is heated to above body temperature. This water is then mixed with colder water from the storage tank so that the discharged water is approximately body temperature.

A discharge nozzle is configured to receive and mix the heated water from the heating water dispensing system and powdered baby formula from the hopper for delivery to a baby bottle. Preferably, the heated water is introduced into the discharge nozzle at an angle to create a swirling mass of heating water for mixing with the powdered baby formula.

In a particularly preferred embodiment, a control circuit having a switch operates the baby formula stirring and dispensing mechanism and the heating water dispensing system, such that the dispensed volume of powdered baby formula corresponds with the dispensed water of heated water in response to activation of the switch. The switch may be positioned for actuation by a baby bottle placed under the discharge nozzle. The control circuit can be designed so as to provide continuous flow while the switch is activated, or a metered amount each time the switch is activated.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an exploded perspective view of the device of the present invention and a base thereof;

FIG. 2 is a perspective view of the device, illustrating covers thereof opened to show a removable water tank and powdered baby formula hopper;

FIG. 3 is a partially fragmented and perspective view of various internal components of the device of the present invention;

FIG. 4 is an exploded and partially fragmented perspective view illustrating removal of the powdered baby formula hopper and a discharge nozzle from the device, and also illustrating a heater reservoir exploded from a heating element of the device;

FIG. 5 is a partially fragmented and perspective view of a water storage tank used in accordance with the present invention removed from a pump coupling;

FIG. 6 is a partially fragmented and perspective view of the hopper and baby formula stirring and dispensing mechanism, used in association with the present invention;

FIG. 7 is a side perspective view of the discharge nozzle used in accordance with the present invention, and illustrating a swirling water and baby formula mixture;

FIG. 8 is a top plan view taken generally along line 8-8 of FIG. 7;

FIG. 9 is a rear perspective view of the device of the present invention;

FIG. 10 is a rear and partially fragmented perspective view of the device, illustrating various internal components thereof;

FIG. 11 is a rear and partially fragmented perspective view, illustrating various components of the device used in accordance with the present invention; and

FIG. 12 is a front and side partially fragmented perspective view of another embodiment of the present invention, wherein heated water and cooler water are mixed to body temperature.

### DETAILED DESCRIPTION OF THE PREFERRED EMBODIMENTS

As illustrated in the accompanying drawings for purposes of illustration, the present invention resides in a device, generally referred to by the reference number 10, which automatically warms water and mixes it with an appropriate amount of powdered baby formula to create a warm mixture of liquid baby formula which is dispensed into a baby bottle. The device 10 is sized and configured such so as to be placed in the baby's room, such as next to the crib. The device 10 allows a parent or caretaker to place a bottle under an outlet and depress a button or otherwise activate the device 10 so that in a matter of only a few seconds a bottle of warm baby formula is ready for feeding. This enables the parent or caretaker to hold and soothe the baby while simultaneously creating the bottle of baby formula. The device 10 also dramatically reduces the time necessary to create a bottle, thus allowing both the baby and parent to obtain more sleep during the evening hours.

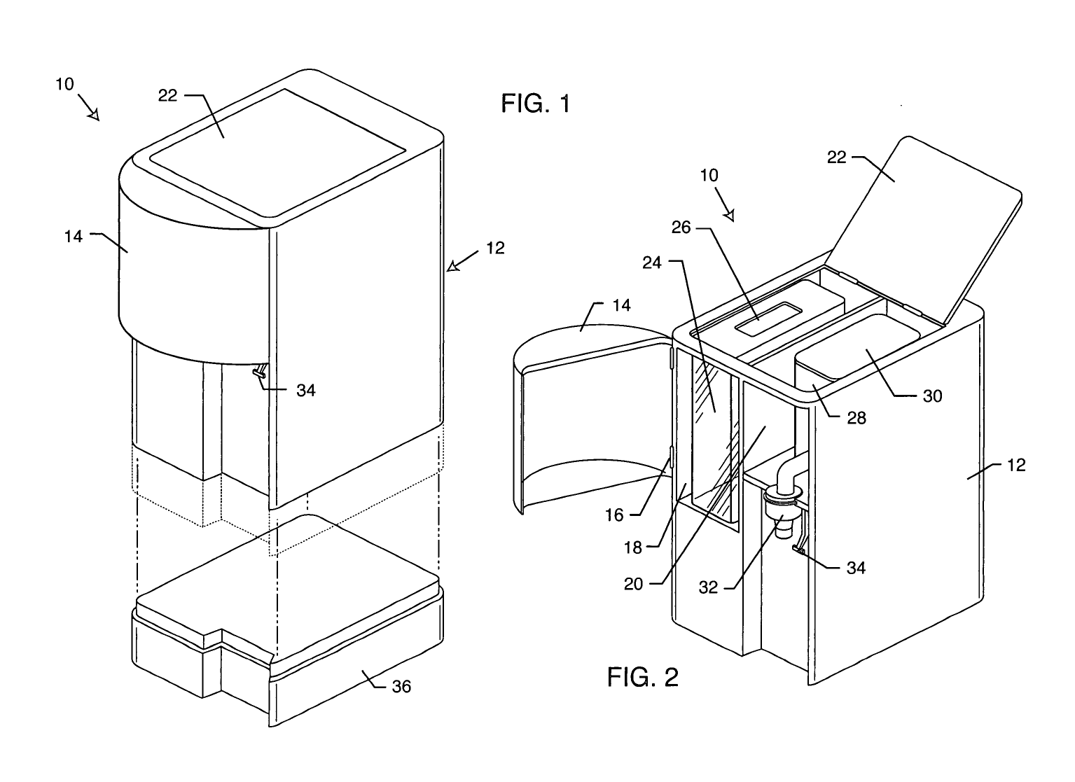

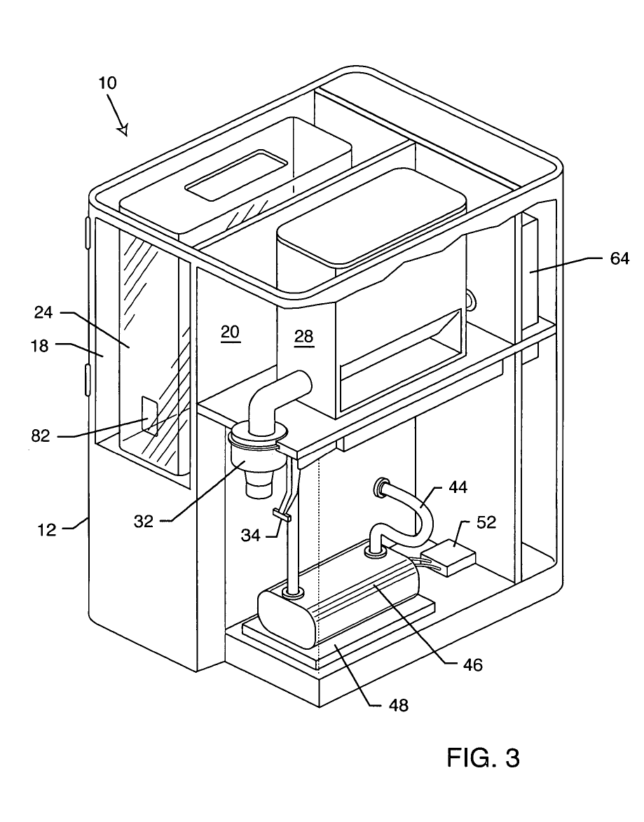

With reference to FIGS. 1 and 2, the device 10 includes outer walls defining a housing 12 which serve to encase the various internal components of the device 10. The housing 12 may be comprised of sheet metal or more preferably plastic so as to be sufficiently durable, yet light-weight. In a particularly preferred embodiment, the housing includes a front cover 14 which is pivotally connected to a side wall of the housing 12 with hinges 16 so as to be selectively opened for access to a water storage tank compartment 18 and a powdered baby formula hopper compartment 20, as illustrated in FIG. 2. A top cover 22 may also be pivotally or removably connected to a top wall of the housing 12 so as to access various components from the top of the device 10.

A water storage tank 24 is operably positioned within the water storage compartment 18, as will be more fully discussed herein. The water storage tank 24 may include an opening 26, such as a permanent opening, an opening 26 accessible through a door, or the removal of a lid of the water storage tank 24 or the like so as to access the contents of the water storage tank 24. This enables water to be added directly to the water storage tank 24 at the unit 10 itself. Alternatively, as will be described more fully herein, the water storage tank 24 is removable from the unit 10 for filling elsewhere such as at a kitchen sink or the like.

The top lid or cover 22 of the device 10 also permits access to a powdered baby formula hopper 28, such as by opening the lid 30 of the hopper 28. In this manner, the contents of a can of powdered baby formula can be emptied therein. As will be more fully described herein, the hopper 28 is also removable from the device 10 for filling at another location such as a kitchen, or cleaning, etc.

As will be more fully described herein, heated water and powdered baby formula are dispensed into a discharge nozzle 32 once a switch 34, such as the illustrated push-lever switch, is activated, such as by depressing a bottle (not shown) against the push-lever switch 34 below the discharge nozzle 34.

As discussed above, the device 10 is sized and configured such as to be placed in baby's room, such as next to the crib, on a changing table, dresser, end table or the like. A platform or base 36, as illustrated in FIG. 1, may be used to securely support the device 10 on such surface. Another purpose of such platform 36 is to elevate the overall height of the device 10 such that a larger baby bottle may be placed under the discharge nozzle 32 to activate the switch 34.

With reference now to FIGS. 3-5, as mentioned previously, the water storage tank 24 is removable from the housing 12 of the device 10. This enables the water storage tank 24 to be filled at another location, such as a kitchen sink or the like, so that filtered water or the like may be added thereto, and any spills will not adversely impact the surrounding baby furniture, etc. Preferably, the storage tank 24 is of a sufficient volume to hold a considerable amount of water, such as several quarts of water for making many 2 ounce to 8 ounce baby bottles.

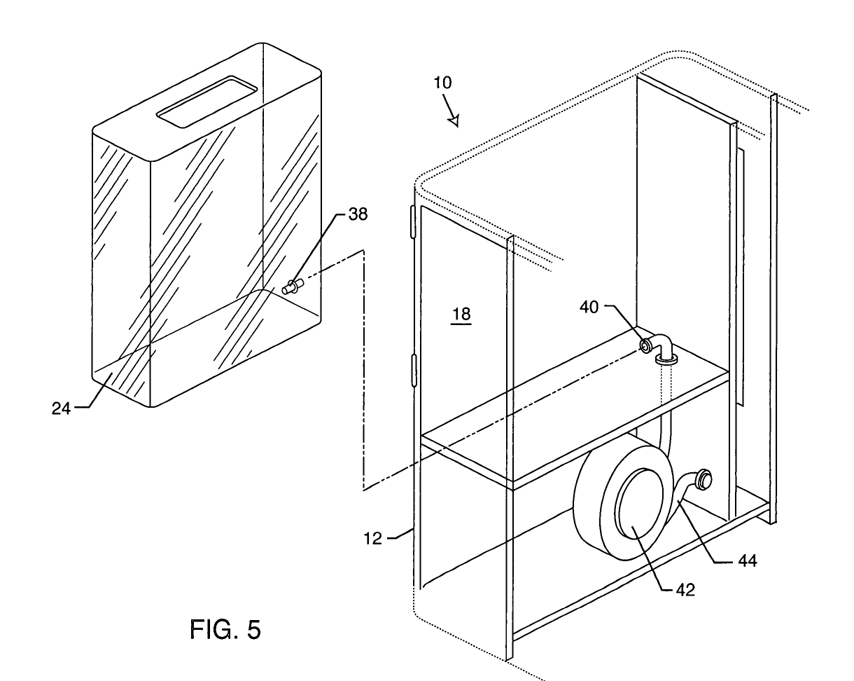

As illustrated in FIG. 5, the water storage tank 24 includes a valve 38, such as a Cooper valve which serves to prevent water from flowing out of the storage tank 24 until the storage tank is disposed within the compartment 18 of the housing 12, and the valve 38 comes into engagement with an open conduit or coupling 40. This engagement causes the valve 38 to open and allow water to flow from the storage tank 24. The valve can comprise a Copper valve or the like, wherein a male valve member 38 is inserted into a female coupling 40, or a one-way valve wherein the coupling of the conduit 40 is the male, and valve 38 is a female member.

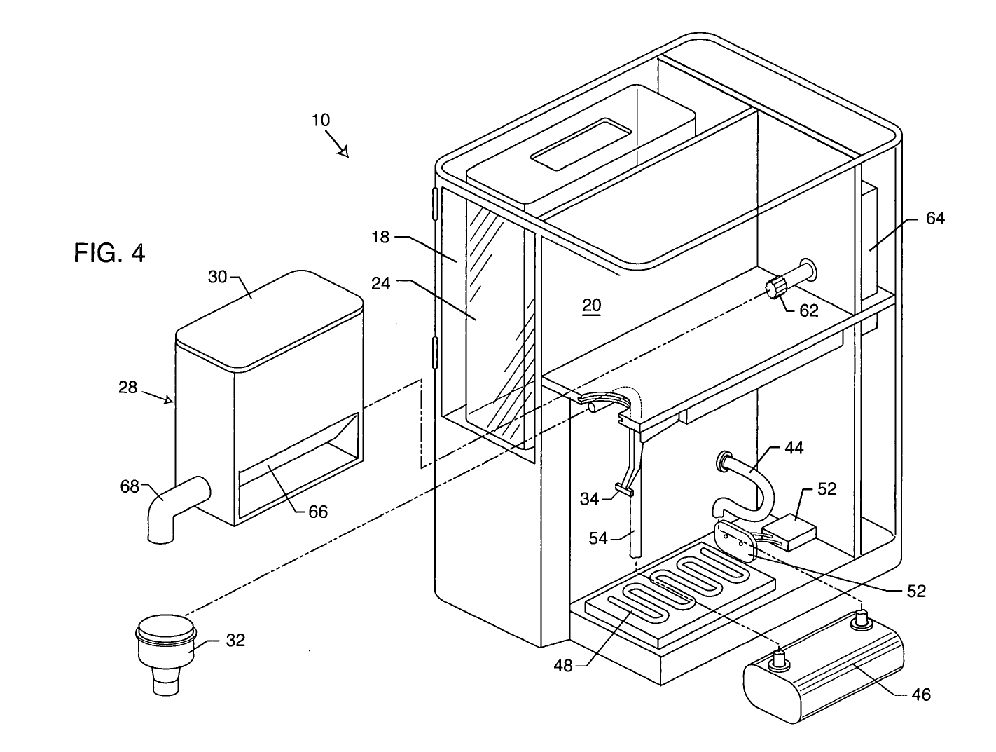

A pump 42 is operably associated with the conduit 40 for drawing water from the storage tank 24 to a conduit 44 and into a heater reservoir 46, as illustrated in FIGS. 3 and 4. The heater reservoir 46 is preferably smaller in volume than the storage tank 24 so as to facilitate the heating of the water therein. Typically, the heater reservoir 46 will have between 6 and 12 ounces volume capacity so as to enable the end user to make more than one bottle, such as if the parent has twins or a toddler who will drink a larger amount.

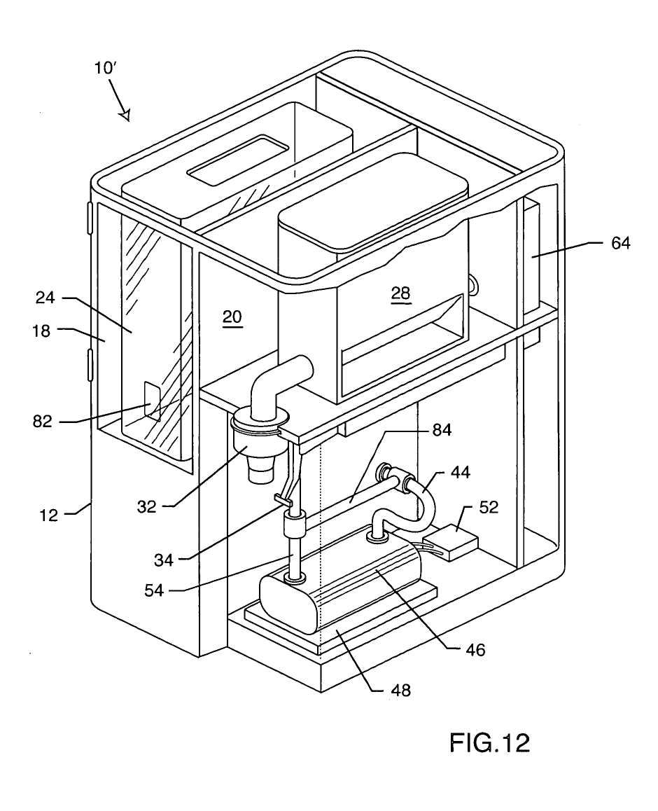

A heater 48 is operably associated with the heater reservoir 46 so as to heat the water therein to a predetermined and desired temperature. As illustrated, the heater 48 includes a heating element in direct contact with the heater reservoir 46, which is preferably comprised of a metal material so as to conduct the heat thereto. It will be understood that the heater 48 can also be different types of heaters, such as within the heating reservoir 46. In the embodiment illustrated in FIGS. 1-11, the heater 48 heats the water within the heater reservoir 46 to approximately body temperature, so as to be palatable to the baby. Further to this objective, a temperature sensor 50, such as the illustrated bi-metal thermostat is operably connected to the heater reservoir 46, so as to control the amount of heat imparted by the heater 48 to heat and retain the water within the heater reservoir 46 at approximately body temperature. The temperature sensor 50 may be connected to an electronic circuit 52 so as to control the heater 48 in this regard.

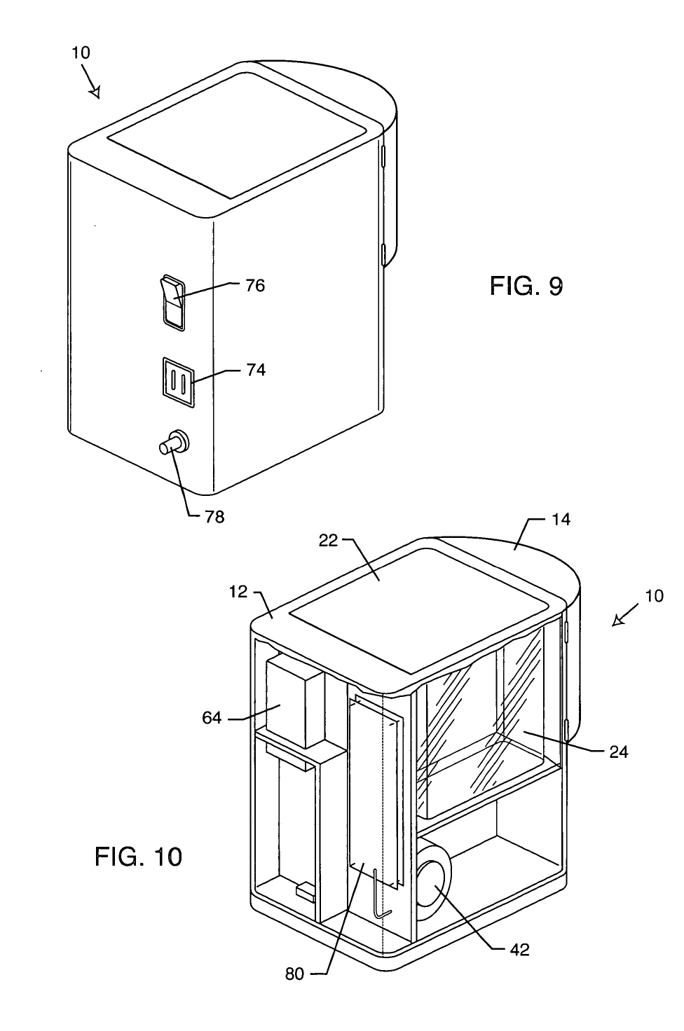

When the switch 34 is activated, such as by pressing a bottle against the lever, the pump 42 is activated, such as by control circuitry and or switches, so as to pump water from the storage tank 24 into the heater reservoir 46 and force water from the heater reservoir 46 through a conduit 54 into the discharge nozzle 32, as illustrated in FIGS. 7 and 8. In a particularly preferred embodiment, the conduit 54 introduces the heated water at an angle with respect to the inner wall of the discharge nozzle 32 so as to create a swirling mass or vortex of water therein until it exits an outlet 56 of the discharge nozzle 32. This allows the powdered baby formula discharged from hopper 28 to be mixed with the warm water as it is discharged into the bottle or other container.

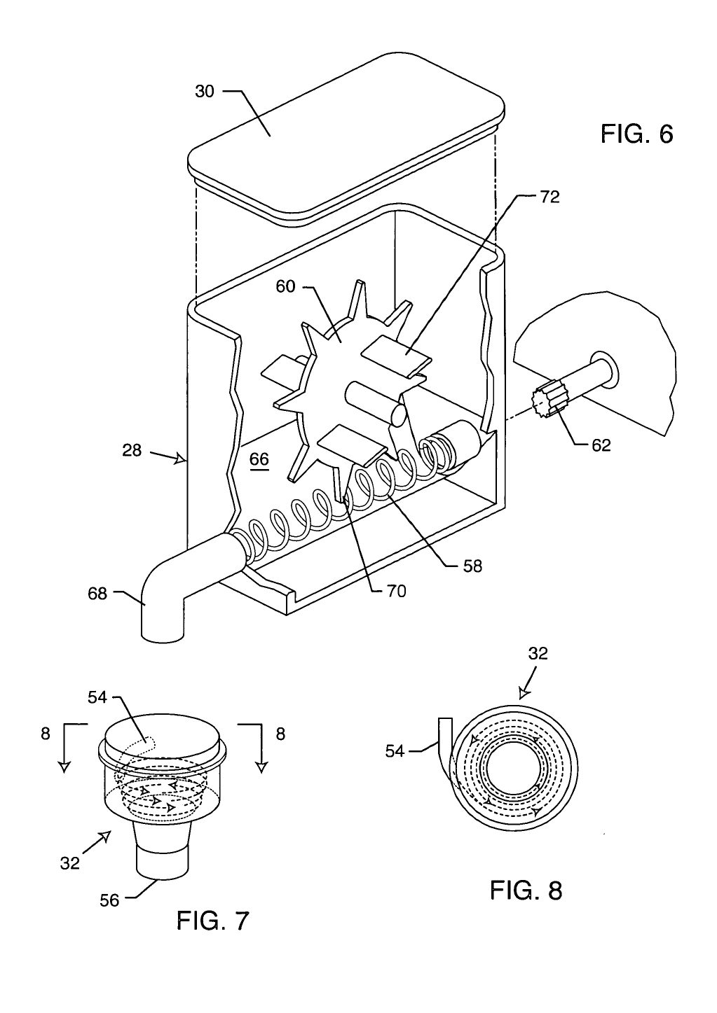

With reference now to FIGS. 4 and 6, the hopper 28, as described above, includes a lid 30 for accessing an internal chamber thereof which can hold a predetermined amount of powdered baby formula. Preferably, the hopper 28 has a volume at least as great as a standard can of baby formula, and may be large enough to accommodate several cans of powdered baby formula.

A problem encountered with many past mixing devices, is that the dry powder can settle and become difficult to dispense in an appropriate and consistent amount. Many prior art mixing devices utilized complicated agitating or mixing devices, which can be expensive and prone to breakage. Moreover, agitating or shaking the powder can further aggravate the settling and packing problem. Therefore, the present invention implements the stirring and dispensing mechanism in the form of a rotatable auger 58 and mixing wheel 60. The auger 58 is preferably of a spring or wire type, as illustrated, so as to be somewhat flexible. An end of the auger 58 includes a gear or coupling which operably engages with a gear or coupling 62 extending from a motor 64 which rotates the gear 62, and thus the auger 28. The auger is positioned in a lower portion of the hopper 58, whose lower walls 66 slant inwardly so as to direct the powdered baby formula into the auger 58. The auger 58 is open to the contents of the hopper 28, and extends to an outlet tube 68 which is positioned immediately above the discharge nozzle 32.

As can be seen in FIG. 4, the discharge nozzle 32 preferably fits substantially co-planar with a base platform of the compartment 20, such that the hopper 28 can be selectively removed from the device 10.

The mixing wheel 60 includes teeth 70 spaced apart from one another and extending into the auger 58, such that the rotation of the auger 58 causes the mixing wheel 60 to rotate. It will be appreciated that the mixing wheel 60 freely rotates within the hopper 28. Preferably, the mixing wheel includes paddles 72 extending outwardly therefrom so as to stir and churn the powdered baby formula. The paddle 72 can be configured such so as to also push and move the powdered baby formula toward the outlet 68.

In use, an extension cord or the like is inserted into outlet 74, or an electrical cord from the device tolO is plugged into a wall outlet. Of course, the device 10 can be battery-powered, although it is typically powered by electricity in the house. An on/off switch 76 is used to power the device 10. The water storage tank 24 is filled with water and operably engaged with the pump 42. At this point, in order to fill the heater reservoir 46 and prime the overall system, a primer switch 78, as illustrated in FIG. 9, may be used to activate only the pump 42 and draw water into the heater reservoir 46 and eventually into the discharge nozzle 32. The purpose of this is to fill the conduits and heater reservoir 46 with water while not wasting the expensive powdered baby formula which would otherwise be discharged from the hopper 28. Alternatively, a bottle or cup can be pressed against the switch 34 before baby powder is placed into the hopper 28 such that although the auger 58 and mixing wheel 60 will be activated, no baby formula will be dispensed while the water fills the heating reservoir 46 and is eventually discharged into the dispensing nozzle 32.

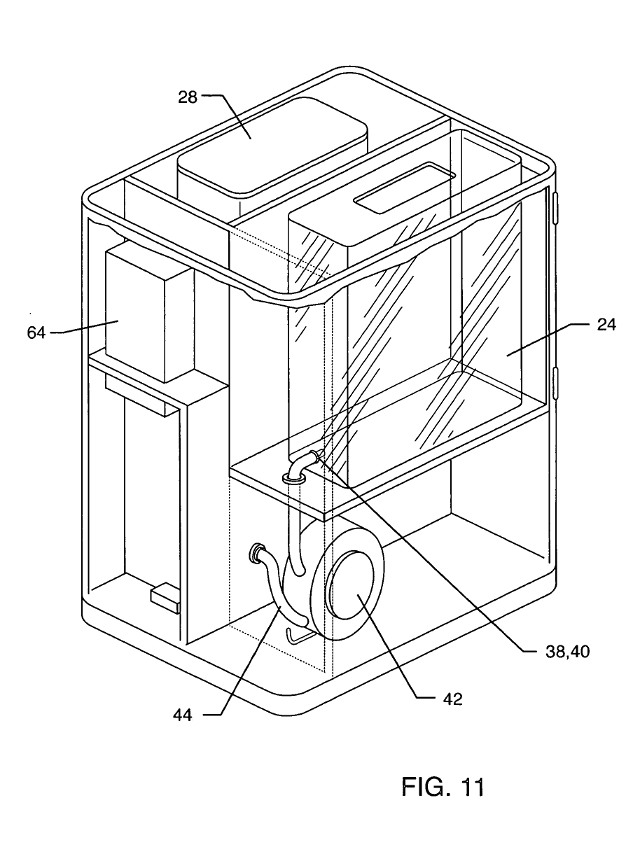

With reference to FIG. 10, the device 10 includes the appropriate electronics and circuitry 80 for performing the functions described herein. For example, the electronic circuitry 80 may include a transformer for transforming the 120V of alternating current into a lower direct current voltage for operating the pump 42, motor 64, heater and other electrically powered devices. As described above, the electronic circuitry 80 is also used to activate the pump 42 and motor 64 such that corresponding amounts of heated water and powdered baby formula are dispensed to create a desired consistency and the end product dispensed into the bottle.

In a particularly preferred embodiment, the pump 42 is activated before the motor 64. This results in heated water flowing into the discharge nozzle 32 and creating a swirling vortex of water before the baby powder is discharged into the nozzle 32. This provides many benefits. First, the powdered baby formula mixes much more consistently, without clumps when swirling water is already present. Also, it keeps the discharge nozzle 32 relatively clean.

In one embodiment, depressing the switch 34 causes a continuous activation of the pump 42, motor 64 and other components such that a constant stream of mixed baby formula is produced while the switch 34 is depressed. However, the electronic circuitry 80 can be configured such that for each depression or activation of the switch 34, a metered amount of baby formula is produced, such as 2 ounces, 4 ounces, 8 ounces, etc.. In fact, each activation of the switch 34 could result in 2 ounce increments of baby formula. The parent could then depress the switch 2, 3 or 4 times depending upon whether the parent wanted 4 ounces to 8 ounces of mixed baby formula.

In a particularly preferred embodiment, the water storage tank 24 includes a low water indicator 82. This could be comprised of a mechanical floating ball mechanism, or a float coupled to a lense which when reaching a predetermined low point would change the lense from green to red or the like. Alternatively, the low water level indicator could be electronic in nature and comprise a sensor which would activate a flashing light or audible alarm in the event of a low water condition. The device 10 may include additional lights, control panels and switches as necessary to indicate that the device 10 is powered, that the water is at appropriate temperature, for indicating when water temperature is too hot and automatically shutting off the system, etc. The housing 12 could also be designed such so as to contain nipples, rings, bottles, plastic bags, etc., such as in a side compartment, or in a compartment below the water tank 24 or the like.

With reference now to FIG. 12, in another embodiment of the invention, the heater 48 heats the water within the heater reservoir 46 to a temperature much higher than body temperature. Another conduit 84 extends from the pump 42 or conduit 44 and extends to either the outlet conduit 54, or even to the discharge nozzle 32. This device 10′ is designed such that a metered amount of hot water from the heater reservoir 46 is combined with a cooler ambient temperature water stream from the conduit 84 such that when they are mixed, the water temperature is equalized to approximately body temperature. This can be accomplished using internal control valves in the conduits 44, 54 and 84, utilizing a secondary pump, or altering the diameters of the conduits 44, 54 and 84 such that the necessary volumes of heated water and ambient temperature water are combined together This embodiment is beneficial in that less heated water is required from the reservoir 46. This would enable energy savings in that the heater 48 would need to heat less water over a given amount of time, and the heating reservoir 46 could actually be decreased in size. A potential problem with a smaller heater reservoir 46 is that once a bottle has been prepared, colder ambient temperature water from the water storage tank is pumped into the heater reservoir 46 lowering the overall temperature of the water within the reservoir 46. If another bottle is made shortly after the first bottle, the water temperature may not have yet been heated to body temperature, and may not be palatable to the baby.

As illustrated in FIG. 4, preferably the dispenser nozzle 32 is removable from the device 10. This enables the discharge nozzle 32 to be cleaned as necessary. Also, the discharge nozzle 32 could be comprised of a plastic having temperature sensitive compounds such that the discharge nozzle 32 changes color in the event that the prepared formula is below a certain temperature, or too hot. Of course, the electronic circuitry 80 could also be used to determine this and provide the necessary visual or audible alarm, or even shut-off the device 10 for safety purposes.

Those skilled in the art will appreciate that the device 10 of the present invention allows the parent orcaretakerto conveniently mix baby formula and assemble a bottle with only one hand in a very short time. Thus, the baby can be held while the bottle is made.

Although the embodiments have been described in detail for purposes of illustration, various modifications may be made without departing from the scope and spirit of the invention. Accordingly, the invention is not to be limited, except as by the appended claims.

1. A device for preparing baby formula, comprising:
a powdered baby formula hopper;
a baby formula stirring and dispensing mechanism operably associated with the hopper for stirring the powdered baby formula and dispensing a desired quantity of the powdered baby formula from the hopper;
a heated water dispensing system for controllably dispensing a desired quantity of heated water, comprising:
a water storage tank;
a water heating reservoir fluidly coupled to the storage tank; and
a heater operably associated with the heating reservoir for heating water within the heating reservoir to a predetermined temperature; and
a discharge nozzle configured to receive and mix heated water from the heated water dispensing system and powdered baby formula from the hopper for delivery to a baby bottle.

2. The device of claim 1, wherein the hopper is removable from a housing of the device.

3. The device of claim 1, wherein the stirring and dispensing mechanism includes a motor-driven auger positioned in a lower portion of the hopper.

4. The device of claim 4, including a mixing wheel disposed in the hopper and having teeth engageable with the auger so as to rotate the mixing wheel as the auger is rotated.

5. The device of claim 1, wherein the heated water dispensing system includes a pump for pumping water from the storage tank to the heating reservoir and to the discharge nozzle.

6. The device of claim 1, wherein the heating reservoir has a smaller volume than the storage tank.

7. The device of claim 1, wherein the storage tank is removable from a housing of the device, and includes an outlet having a valve adapted to permit water to flow from the storage tank to the heating reservoir.

8. The device of claim 1, including a temperature sensor operably associated with the heating reservoir and heater.

9. The device of claim 1, wherein the heated water is introduced into the discharge nozzle at an angle to create a swirling mass of heated water for mixing with the powdered baby formula.

10. The device of claim 1, including a control circuit having a switch and adapted to operate the baby formula stirring and dispensing mechanism and the heated water dispensing system such that the dispensed volume of powdered baby formula corresponds with the dispensed volume of heated water in response to activation of the switch.

11. The device of claim 10, wherein the switch is positioned for actuation by a baby bottle placed under the discharge nozzle.

12. The device of claim 1, wherein the heated water dispensing system is configured to heat water in the heater reservoir above body temperature, and mix water from the storage tank with heated water discharged from the heating reservoir such that the total volume of discharged water from the heated water dispensing system is approximately body temperature.

13. The device of claim 1, wherein the heater heats the water in the heating reservoir to approximately body temperature.

14. A device for preparing baby formula, comprising:
a powdered baby formula hopper;
a baby formula stirring and dispensing mechanism including a motor-driven auger disposed in a lower portion of the hopper for dispensing a desired quantity of the powdered baby formula from the hopper, and a mixing wheel disposed in the hopper and having teeth engageable with the auger so as to rotate the mixing wheel as the auger is rotated so as to stir the powdered baby formula;
a heated water dispensing system for controllably dispensing a desired quantity of heated water, comprising:
a water storage tank;
a water heating reservoir fluidly coupled to the storage tank and having a smaller volume than the storage tank;
a pump for pumping water from the storage tank to the heating reservoir;
a heater operably associated with the heating reservoir for heating waterwithin the heating reservoirto approximately body temperature;
a temperature sensor operably associated with the heating reservoir and heater;
a control circuit having a switch and adapted to operate the baby formula stirring and dispensing mechanism and the heated water dispensing system such that the dispensed volume of powdered baby formula corresponds with the dispensed volume of heated water in response to activation of the switch; and
a discharge nozzle configured to receive and mix heated water from the heated water dispensing system and powdered baby formula from the hopper for delivery to a baby bottle;
wherein the heated water is introduced into the discharge nozzle at an angle to create a swirling mass of heated water for mixing with the powdered baby formula.

15. The device of claim 14, wherein the hopper is removable from a housing of the device.

16. The device of claim 14, wherein the storage tank is removable from a housing of the device, and includes an outlet having a valve adapted to permit water to flow from the storage tank to the heating reservoir.

17. The device of claim 14, wherein the switch is positioned for actuation by a baby bottle placed under the discharge nozzle.

18. A device for preparing baby formula, comprising:
a powdered baby formula hopper;
a baby formula stirring and dispensing mechanism including a motor-driven auger disposed in a lower portion of the hopper for dispensing a desired quantity of the powdered baby formula from the hopper, and a mixing wheel disposed in the hopper and having teeth engageable with the auger so as to rotate the mixing wheel as the auger is rotated so as to stir the powdered baby formula;
a heated water dispensing system for controllably dispensing a desired quantity of heated water, comprising:
a water storage tank;
a water heating reservoir fluidly coupled to the storage tank and having a smaller volume than the storage tank;
a pump for pumping water from the storage tank to the heating reservoir;
a heater operably associated with the heating reservoir for heating water within the heating reservoir;
a temperature sensor operably associated with the heating reservoir and heater;
wherein the heated water dispensing system is configured to heat water in the heater reservoir above body temperature, and mix water from the storage tank with heated water discharged from the heating reservoir such that the total volume of discharged water from the heated water dispensing system is approximately body temperature;
a control circuit having a switch and adapted to operate the baby formula stirring and dispensing mechanism and the heated water dispensing system such that the dispensed volume of powdered baby formula corresponds with the dispensed volume of heated water in response to activation of the switch; and
a discharge nozzle configured to receive and mix heated water from the heated water dispensing system and powdered baby formula from the hopper for delivery to a baby bottle;
wherein the heated water is introduced into the discharge nozzle at an angle to create a swirling mass of heated water for mixing with the powdered baby formula.

19. The device of claim 18, wherein the hopper is removable from a housing of the device.

20. The device of claim 18, wherein the storage tank is removable from a housing of the device, and includes an outlet having a valve adapted to permit water to flow from the storage tank to the heating reservoir.

21. The device of claim 18, wherein the switch is positioned for actuation by a baby bottle placed under the discharge nozzle.
